(19) United States
(12) Patent Application Publication
(10) Pub. No.: US 2006/0050956 A1
(43) Pub. Date: Mar. 9, 2006

(54) Signal processing apparatus, signal processing method, and signal processing program

(75) Inventor: Seiji Tanaka, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/220,699

(22) Filed: Sep. 8, 2005

(30) Foreign Application Priority Data
Sep. 9, 2004 (JP) 2004-262686

(51) Int. Cl. G06K 9/00

(52) U.S. Cl. 382/162

(57) ABSTRACT

The object of the present invention is to provide a signal processing apparatus, a signal processing method, and a signal processing program that can suppress generation of spurious signals due to interpolation and to improve the diagonal resolution of an image generated by interpolation. According to the present invention, generation of spurious signals due to interpolation can be suppressed. Moreover, the diagonal resolution of an image generated through interpolation can be improved.

### BACKGROUND OF THE INVENTION

1. Field of the Invention

The present invention relates to a signal processing apparatus, a signal processing method, and a signal processing program and, in particular, to an apparatus, method, and program for interpolating color signals.

2. Related Art

Some digital still and video cameras that use a solid-state image sensor such as a CCD image sensor have an array of R (red), G (green) and B (blue) color filters on the acceptance surface of the solid-state image sensor. In such a digital still or video camera, R, G and B color filters are provided in such a manner that one of the R, G, and B color filters corresponds to each pixel locations in the solid-state image sensor. Accordingly, only one color signal can be obtained from one pixel. In order to obtain all of the three color signals, R, G, and B, at every pixel location, color signals outputted from nearby pixels must be interpolated at that pixel.

In such interpolation, conventionally the correlation value between color signals obtained from nearby pixels at each pixel is calculated and the direction in which pixels that output color signals used for the interpolation at the pixel are located is determined on the basis of the calculated correlation value (Japanese Patent Application Laid-Open No. 2001-339735).

However, due to noise generated in the image sensor or its associated circuits, the direction in which pixels that output color signals used for interpolation can be mistakenly determined and consequently the interpolation can produce spurious signals.

In a signal processing method described in Japanese Patent Application Laid-Open No. 11-205808, correlation values are filtered in order to suppress such misdetermination.

### SUMMARY OF THE INVENTION

However, the signal processing methods described in Japanese Patent Application Laid-Open Nos. 2001-339735 and 11-205808 have a problem that when interpolating a G signal at an R- or B-pixel location, misdetermination can be made at locations such as the color boundary between red and blue, because only the color signals obtained from nearby G-pixels are used to determine the direction in which pixels outputting color signals used for the interpolation are located.

Another problem with the signal processing method described in Japanese Patent Laid-Open Nos. 2001-339735 and 11-205808 is that the diagonal resolution of an image generated through interpolation is low. This is because these methods do not give consideration to the correlation between pixels located in the diagonal directions.

The present invention has been made in light of these circumstances and an object of the present invention is to provide a signal processing apparatus, a signal processing method, and a signal processing program that can suppress generation of spurious signals due to interpolation and to improve the diagonal resolution of an image generated by interpolation.

To achieve the objects, a first aspect of the present invention provides a signal processing apparatus which obtains a G color signal at an R-pixel location and a B-pixel location on a solid-state image sensor having a color-filter array including at least red, green and blue filters by interpolating color signals from nearby pixels on the basis of color signals of a plurality of colors outputted from the solid-state image sensor, the signal processing apparatus including: a first correlation value calculating unit which calculates, from the values of color signals obtained from a plurality of pixels around the R-pixel location or the B-pixel location along a first direction and a plurality of pixels around the R-pixel location or the B-pixel location along a second direction different from the first direction, a first correlation value representing the degree of correlation in the first direction and in the second direction; a second correlation value calculating unit which calculates a second correlation value representing the degree of correlation in the first direction and in the second direction by applying two-dimensional filtering to the first correlation value calculated for each R- or B-pixel location in a given two-dimensional range around the R- or B-pixel location; an interpolation direction determining unit which determines, on the basis of the second correlation value, which of the first and second directions has a higher correlation; and an interpolation unit which interpolates color signals obtained from the pixels located along the direction determined by the interpolation direction determining unit to calculate the G color signal at the R-pixel location or the B-pixel location.

According to the first aspect, the accuracy of determination of the interpolation direction can be improved by applying two-dimensional filtering to correlation values, and therefore generation of spurious signals due to interpolation can be suppressed.

Furthermore, in order to achieve the objects, a second aspect of the present invention provides a signal processing apparatus which obtains a G color signal at an R-pixel location and a B-pixel location on a solid-state image sensor having a color-filter array including at least red, green and blue filters by interpolating color signals from nearby pixels on the basis of color signals of a plurality of colors outputted from the solid-state image sensor, the signal processing apparatus including: a first correlation value calculating unit which calculates, from the values of color signals obtained from a plurality of pixels around the R-pixel location, the B-pixel location, and the G-pixel location along a first direction and a plurality of pixels around the R-pixel location, the B-pixel location or the G-pixel location along a second direction different from the first direction, a first correlation value representing the degree of correlation in the first direction and in the second direction; a second correlation value calculating unit which calculates a second correlation value representing the degree of correlation in the first direction and in the second direction by applying two-dimensional filtering to the first correlation value calculated for each R-, B-, or G-pixel location in a given two-dimensional range around the R- or B-pixel location; an interpolation direction determining unit which determines, on the basis of the second correlation value, which of the first and second directions has a higher correlation; and an interpolation unit which interpolates color signals obtained from the pixels located along the direction determined by the interpolation direction determining unit to calculate the G color signal at the R-pixel location or the B-pixel location.

According to the second aspect, the accuracy of determination of the interpolation direction can be improved by applying two-dimensional filtering to correlation values calculated for each R-, B-, or G-pixel location, and therefore generation of spurious signals due to interpolation can be reduced.

In order to achieve the objects described above, a third aspect of the present invention provides a signal processing apparatus which obtains a G color signal at an R-pixel location and a B-pixel location on a solid-state image sensor having a color-filter array including at least red, green and blue filters by interpolating color signals from nearby pixels on the basis of color signals of a plurality of colors outputted from the solid-state image sensor, the signal processing apparatus including: a first correlation value calculating unit which calculates, from the values of color signals obtained from a plurality of pixels around the R-pixel location or the B-pixel location along a first direction and a plurality of pixels around the R-pixel location or the B-pixel location along a second direction different from the first direction, a first correlation value representing the degree of correlation in the first direction and in the second direction; a second correlation value calculating unit which calculates, from the values of color signals obtained from a plurality of pixels around the G-pixel location along a third direction different from the first and second directions and a plurality of pixels around the G-pixel location along a fourth direction different from the third direction, a second correlation value representing the degree of correlation in the third direction and in the fourth direction; a third correlation value calculating unit which calculates a third correlation value representing the degree of correlation in the first direction and in the second direction by applying two-dimensional filtering to the first correlation value calculated for each R- or B-pixel location in a given two-dimensional range around the R- or B-pixel location; a fourth correlation value calculating unit which calculates a fourth correlation value representing the degree of correlation in the third direction and in the fourth direction by applying two-dimensional filtering to the second correlation value calculated for each G-pixel location in a given two-dimensional range around the R- or B-pixel location; an interpolation direction determining unit which determines, on the basis of the third and fourth correlation values, which of the first, second, third, and fourth directions has the highest correlation; and an interpolation unit which calculates the G color signal at the R-pixel location or the B-pixel location by interpolating color signals obtained from the pixels located along the direction determined by the interpolation direction determining unit as having the highest correlation, or by performing weighted interpolation of color signals of pixels in the direction having the highest correlation and color signals of pixels in another direction.

According to the third aspect, the diagonal resolution of an image generated by applying interpolation can be improved by giving consideration to correlations in diagonal directions as well as the horizontal and vertical directions.

To achieve the objects described above, a fourth aspect of the present invention provides a signal processing method for obtaining a G color signal at an R-pixel location and a B-pixel location on a solid-state image sensor having a color-filter array including at least red, green and blue filters by interpolating color signals from nearby pixels on the basis of color signals of a plurality of colors outputted from the solid-state image sensor, the signal processing method including the steps of: calculating, from the values of color signals obtained from a plurality of pixels around the R-pixel location or the B-pixel location along a first direction and a plurality of pixels around the R-pixel location or the B-pixel location along a second direction different from the first direction, a first correlation value representing the degree of correlation in the first direction and in the second direction; calculating a second correlation value representing the degree of correlation in the first direction and in the second direction by applying two-dimensional filtering to the first correlation value calculated for each R- or B-pixel location in a given two-dimensional range around the R- or B-pixel location; determining, on the basis of the second correlation value, which of the first and second directions has a higher correlation; and an interpolation unit which interpolates color signals obtained from the pixels located along the direction determined by the interpolation direction determining unit to calculate the G color signal at the R-pixel location or the B-pixel location.

According to the fourth aspect, the accuracy of determination of the interpolation direction can be improved by applying two-dimensional filtering to correlation values, and therefore generation of spurious signals due to interpolation can be suppressed.

To achieve the objects described above, a fifth aspect of the present invention provides a signal processing method for obtaining a G color signal at an R-pixel location and a B-pixel location on a solid-state image sensor having a color-filter array including at least red, green and blue filters by interpolating color signals from nearby pixels on the basis of color signals of a plurality of colors outputted from the solid-state image sensor, the signal processing method including the steps of: calculating, from the values of color signals obtained from a plurality of pixels around the R-pixel location, the B-pixel location, and the G-pixel location along a first direction and a plurality of pixels around the R-pixel location, the B-pixel location or the G-pixel location along a second direction different from the first direction, a first correlation value representing the degree of correlation in the first direction and in the second direction; calculating a second correlation value representing the degree of correlation in the first direction and in the second direction by applying two-dimensional filtering to the first correlation value calculated for each R-, B-, or G-pixel location along a given two-dimensional range around the R- or B-pixel location; determining, on the basis of the second correlation value, which of the first and second directions has a higher correlation; and interpolating color signals obtained from the pixels located along the direction determined by the interpolation direction determining unit to calculate the G color signal at the R-pixel location or the B-pixel location.

According to the fifth aspect, the accuracy of determination of the interpolation direction can be improved by applying two-dimensional filtering to correlation values calculated for each R-, B-, or G-pixel location, and therefore generation of spurious signals due to interpolation can be reduced.

To achieve the objects described above, a sixth aspect of the present invention provides a signal processing method for obtaining a G color signal at an R-pixel location and a B-pixel location on a solid-state image sensor having a color-filter array including at least red, green and blue filters by interpolating color signals from nearby pixels on the basis of color signals of a plurality of colors outputted from the solid-state image sensor, the signal processing method including the steps of: calculating, from the values of color signals obtained from a plurality of pixels around the R-pixel location or the B-pixel location along a first direction and a plurality of pixels around the R-pixel location or the B-pixel location along a second direction different from the first direction, a first correlation value representing the degree of correlation in the first direction and in the second direction; calculating, from the values of color signals obtained from a plurality of pixels around the G-pixel location along a third direction different from the first and second directions and a plurality of pixels around the G-pixel location along a fourth direction different from the third direction, a second correlation value representing the degree of correlation in the third direction and in the fourth direction; calculating a third correlation value representing the degree of correlation in the first direction and in the second direction by applying two-dimensional filtering to the first correlation value calculated for each R- or B-pixel location in a given two-dimensional range around the R- or B-pixel location; calculating a fourth correlation value representing the degree of correlation in the third direction and in the fourth direction by applying two-dimensional filtering to the second correlation value calculated for each G-pixel location in a given two-dimensional range around the R- or B-pixel location; determining, on the basis of the third and fourth correlation values, which of the first, second, third, and fourth directions has the highest correlation; and calculating the G color signal at the R-pixel location or the B-pixel location by interpolating color signals obtained from the pixels located along the direction determined by the interpolation direction determining unit as having the highest correlation, or by performing weighted interpolation of color signals of pixels in the direction having the highest correlation and color signals of pixels in another direction.

According to the sixth aspect, the diagonal resolution of an image generated by applying interpolation can be improved by giving consideration to correlations in diagonal directions as well as the horizontal and vertical directions.

To achieve the objects described above, a seventh aspect of the present invention provides a signal processing program for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing program causing a computer to implement the functions of: calculating, from the values of color signals obtained from a plurality of pixels around the R-pixel location or the B-pixel location along a first direction and a plurality of pixels around the R-pixel location or the B-pixel location along a second direction different from the first direction, a first correlation value representing the degree of correlation in the first direction and in the second direction; calculating a second correlation value representing the degree of correlation in the first direction and in the second direction by applying two-dimensional filtering to the first correlation value calculated for each R- or B-pixel location in a given two-dimensional range around the R- or B-pixel location; determining, on the basis of the second correlation value, which of the first and second directions has a higher correlation; and an interpolation unit which interpolates color signals obtained from the pixels located along the direction determined by the interpolation direction determining unit to calculate the G color signal at the R-pixel location or the B-pixel location.

According to the seventh aspect, the accuracy of determination of the interpolation direction can be improved by applying two-dimensional filtering to correlation values, and therefore generation of spurious signals due to interpolation can be suppressed.

To achieve the objects described above, an eighth aspect of the present invention provides a signal processing program for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing program causing a computer to implement the functions of: calculating, from the values of color signals obtained from a plurality of pixels around the R-pixel location, the B-pixel location, and the G-pixel location along a first direction and a plurality of pixels around the R-pixel location, the B-pixel location or the G-pixel location along a second direction different from the first direction, a first correlation value representing the degree of correlation in the first direction and in the second direction; calculating a second correlation value representing the degree of correlation in the first direction and in the second direction by applying two-dimensional filtering to the first correlation value calculated for each R-, B-, or G-pixel location along a given two-dimensional range around the R- or B-pixel location; determining, on the basis of the second correlation value, which of the first and second directions has a higher correlation; and interpolating color signals obtained from the pixels located along the direction determined by the interpolation direction determining unit to calculate the G color signal at the R-pixel location or the B-pixel location.

According to the eighth aspect, the accuracy of determination of the interpolation direction can be improved by applying two-dimensional filtering to correlation values calculated for each R-, B-, or G-pixel location, and therefore generation of spurious signals due to interpolation can be reduced.

To achieve the objects described above, a ninth aspect of the present invention provides a signal processing program for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing program causing a computer to implement the functions of: calculating, from the values of color signals obtained from a plurality of pixels around the R-pixel location or the B-pixel location along a first direction and a plurality of pixels around the R-pixel location or the B-pixel location along a second direction different from the first direction, a first correlation value representing the degree of correlation in the first direction and in the second direction; calculating, from the values of color signals obtained from a plurality of pixels around the G-pixel location along a third direction different from the first and second directions and a plurality of pixels around the G-pixel location along a fourth direction different from the third direction, a second correlation value representing the degree of correlation in the third direction and in the fourth direction; calculating a third correlation value representing the degree of correlation in the first direction and in the second direction by applying two-dimensional filtering to the first correlation value calculated for each R- or B-pixel location in a given two-dimensional range around the R- or B-pixel location; calculating a fourth correlation value representing the degree of correlation in the third direction and in the fourth direction by applying two-dimensional filtering to the second correlation value calculated for each G-pixel location in a given two-dimensional range around the R- or B-pixel location; determining, on the basis of the third and fourth correlation values, which of the first, second, third, and fourth directions has the highest correlation; and calculating the G color signal at the R-pixel location or the B-pixel location by interpolating color signals obtained from the pixels located along the direction determined by the interpolation direction determining unit as having the highest correlation, or by performing weighted interpolation of color signals of pixels in the direction having the highest correlation and color signals of pixels in another direction.

According to the present invention, generation of spurious signals due to interpolation can be suppressed. Furthermore, according to the present invention, the diagonal resolution of an image generated through interpolation can be improved.

### BRIEF DESCRIPTION OF THE DRAWINGS

FIG. 1 is a block diagram of an electronic camera to which a signal processing apparatus and a signal processing method according to an embodiment of the present invention are applied;

FIG. 2 shows a Bayer-pattern-color-filter array;

FIG. 3 is a block diagram of an interpolation unit according to a first embodiment of the present invention;

FIG. 4 shows an array of data used for calculating correlation values;

FIG. 5 shows calculated correlation values arranged correspondingly to pixel locations;

FIGS. 6A and 6B are schematic diagrams of a two-dimensional filter;

FIG. 7 is a flowchart of a process performed in a signal processing apparatus according to the first embodiment of the present invention;

FIG. 8 is a block diagram of an interpolation unit according to a second embodiment of the present invention;

FIGS. 9A and 9B show arrays of data used for calculating correlation values;

FIG. 10 shows calculated correlation values arranged correspondingly to pixel locations;

FIGS. 11A and 11B are schematic diagram of a two-dimensional filter;

FIG. 12 is a flowchart of a process performed in a signal processing apparatus according to the second embodiment of the present invention;

FIG. 13 is a block diagram of an interpolating unit according to a third embodiment of the present invention;

FIG. 14 shows an array of data used for calculating correlation values;

FIG. 15 shows an array of data used for calculating correlation values;

FIG. 16 shows calculated correlation values arranged correspondingly to pixel locations;

FIG. 17 shows calculated correlation values arranged correspondingly to pixel locations;

FIGS. 18A and 18B are schematic diagrams of a two-dimensional filter;

FIG. 19 shows an array of data used for diagonal interpolation; and

FIG. 20 is a flowchart of a process performed in a signal processing apparatus according to the second embodiment of the present invention.

### DETAILED DESCRIPTION OF THE PREFERRED EMBODIMENTS

Preferred embodiments of a signal processing apparatus, a signal processing method, and a signal processing program according to the present invention will be described below in detail with reference to the accompanying drawings.

### First Embodiment

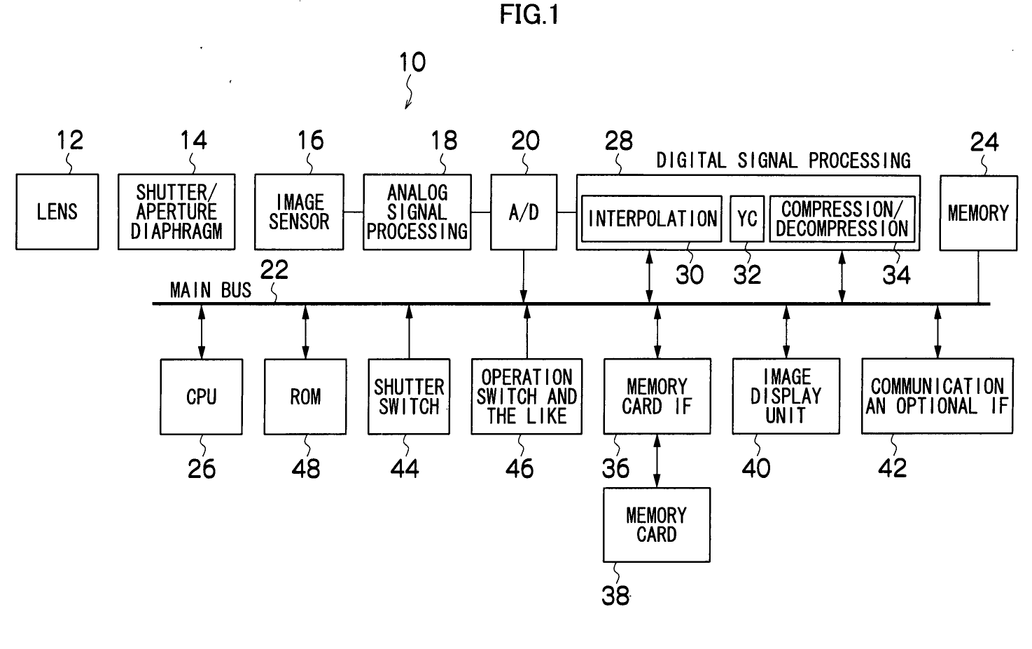

FIG. 1 is a block diagram of an electronic camera to which a signal processing apparatus and a signal processing method according to a first embodiment of the present invention are applied. The camera 10 is a single-panel digital camera. Light passing through a taking lens 12 and a mechanical shutter and aperture diaphragm 14 forms an image on the acceptance surface of an image pickup device 16. The mechanical shutter prevents light from entering the image pickup device 16 and causing smears or the like while signals are being read from the image pickup device 16. The aperture diaphragm mechanism controls the amount of light that enters the image pickup device 16.

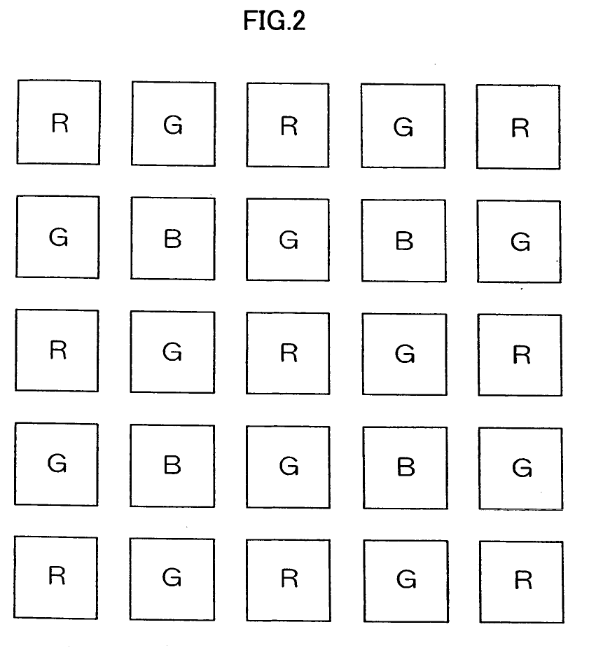

While a CCD (charge-coupled device) is used as the image pickup device 16 in this example, any other devices using other technologies, such as CMOS-based devices, may also be used. Many photo acceptance elements (photodiodes) are arranged in the form of a two-dimensional array on the acceptance surface of the image pickup device 16. A color separation filter array consisting of three color filters, R, G, and B filters, not shown, is provided in front of the acceptance surface. In this example, a so-called Bayer-pattern color filter array as shown in FIG. 2 is provided. As shown in FIG. 2, a Bayer-pattern color filter array has a filter arrangement in which G pixels are horizontally and vertically adjacent to an R- or B-pixel location and one of the R, G, and B color filters is located correspondingly to the location of each light acceptance element (pixel location) of the image pickup device 16. An image of a scene formed on the acceptance surface of the image pickup device 16 is converted by each photo acceptance element into an amount of signal charge proportional to the amount of incident light. The signal charge stored in each photo acceptance element is read out onto a transfer channel of the CCD by a read gate pulse applied from a driving circuit, not shown, and sequentially outputted as voltage signals (image signals) proportional to the signal charge.

Because one of R, G, and B color filters is provided at each pixel location, image signals outputted from the image pickup device 16 include only one color signal.

The image pickup device 16 is driven by a timing signal generated by a timing generator, not shown, and outputs an image signal. The image signal outputted from the image pickup device 16 is transmitted to an analog signal processing unit 18. The analog signal processing unit 18 includes a sampling hold circuit, a color separation circuit, a gain control, circuit, and other circuits. The image signal inputted into the analog signal processing unit 18 undergoes correlated double sampling (CDS) and is separated by a color separation process into three color signals, R, G, and B. Then, the signal level of each color signal is adjusted (pre-white balance process).

The image signal generated by the analog signal processing unit 18 is converted by an A/D converter 20 to a digital signal, which is then temporarily stored in a memory 24 through a bus (the main bus in the camera) 22. A portion of this memory 24 is used as a working area for computation by a CPU 26.

The image signal stored in the memory 24 is sent to a digital signal processing unit 28 through the bus 22. The digital signal processing unit 28 is a signal processing device having processing units such as an interpolating unit 30, a luminance/chrominance signal generating (YC conversion) unit 32, a data compression/decompression unit 34, and applies image processing to the image signal through the use of the memory 24 according to a command from the CPU 26.

The image signal inputted in the digital signal processing unit 28 undergoes predetermined processes such as interpolation and YC conversion and then compressed in accordance with a predetermined compression format, such as JPEG, and recorded in a memory card 38 as image data through a memory card interface unit 36. It should be noted that the compression format is not limited to JPEG. Any of various other formats such as MPEG and a compression engine that supports the compression format may be used.

The device for recording image data is not limited to a semiconductor memory such as the memory card 38. Any of various recording media such as a magnetic disk, an optical disk, and a magneto-optical disk may be used. The device is not limited to a recording medium removable from the camera 10; it may be a recording medium built in the camera 10 (internal memory).

A mode (RAW data recording mode) may be added to the camera 10 in which unprocessed image data (CCD-RAW data) to which image processing such as interpolation, YC conversion or compression, has not been applied is stored in the memory card 38.

In reproduction mode, image data is read from the memory card 38, decompressed in the digital signal processing unit 28, and then converted into signals for display, and outputted to an image display unit 40. The image display unit 40 may be a display device such as a liquid-crystal display or an organic electroluminescence display. The image display unit 40 is also used as a user interface display screen.

The camera 10 also includes a communication/optional interface unit 42 for providing communications connection for sending and receiving data to and from a personal computer or other external devices or for connecting an external optional device. Any of various wired or wireless interface technologies such as USB, IEEE 1394, and Bluetooth can be applied to the communication/optional interface unit 42.

The CPU 26 is a control unit for centrally controlling the camera system according to a given program. The CPU 26 controls operations of the circuits in the camera 10 in accordance with input signals from the shutter switch 44 and other operation switches 46. The operation switches for a user to input instructions include a mode selector switch for selecting an operation mode of the camera 10, a menu switch for displaying a menu, an arrow pad for selecting a menu option (cursor control operation) or entering an instruction to perform a single-frame advance/reverse operation of a playback image, an enter key for confirming a selected option (registration) or instructing to execute an operation, a cancel key for clearing an selected object such as an option or canceling an instruction, a power switch, a zoom switch, and release switch.

The CPU 26 controls the image pickup device 16 according to instruction signals inputted through the shutter switch 44 and operation switches 46 and to shooting conditions (such as exposure, flash on/off, and shooting mode). The CPU 26 also performs automatic exposure (AE) control, automatic focusing (AF) control, automatic white balance (AWB) control, lens driving, image processing control, memory card 38 read/write control, control of display on the image display unit 40, control of communications with external devices, and other controls.

Programs to be executed by the CPU 26 and data required by the CPU 26 (such as location information indicating a faulty pixel, a threshold for finding flaws, and adjustment data) are stored in a ROM 48. The ROM 48, which is a non-volatile memory, may be a non-rewritable or rewritable memory such as an EEPROM.

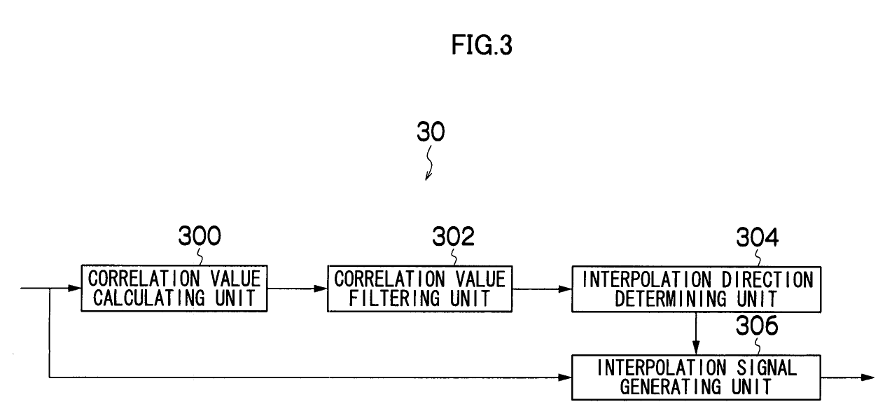

As shown in FIG. 3, the interpolating unit 30 includes a correlation value calculating unit 300, a correlation value filtering unit 302, a interpolation direction determining unit 304, and an interpolation signal generating unit 306.

Operation of the interpolation unit 30 configured as described above will be described below. As described earlier, because only one of R, G, and B color signals can be obtained at each pixel location on the solid-state image sensor, an image signal outputted from the image pickup device 16 is subjected to an interpolation process, which will be described later, to calculate the other two missing color signals at the pixel before being provided to the luminance/chrominance signal generating unit 32. A process for calculating a G-signal at R- or B-pixel location will be described below.

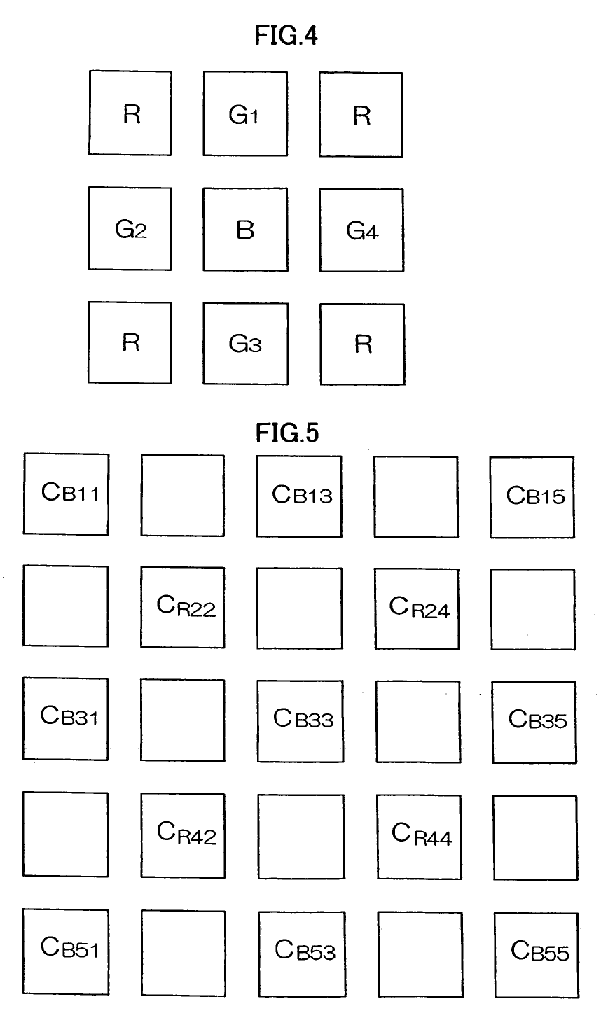

The correlation value calculating unit 300 calculates the correlation value between G-pixels adjacent to an R- or B pixel on the image pickup device 16. For example, to calculate the correlation value between G-pixels adjacent to a B-pixel in the vertical and horizontal directions, data arranged in 3 rows and 3 columns centered on the B-pixel data shown in FIG. 4 is inputted from the image data stored in the memory 24 into the correlation value calculating unit 300 under the control of the CPU 26. As shown in FIG. 4, the 3×3 data includes color signals obtained from the pixel locations of the corresponding colors. The correlation value calculating unit 300 includes a buffer memory, not shown, and temporarily stores the inputted 3×3 data in the buffer memory. The correlation value calculating unit 300 calculates the correlation value CB between the four G pixels around the B-pixel from the 3×3 data held in the buffer memory as follows.
C_{B}=|G1−G4|−G2−G3|

It can be considered that the smaller the absolute value of the difference between color signals, the higher the correlation between the color signals. Accordingly, if the value of C_{B} is negative, the correlation in the direction in which G1 and G4 are located will be higher. On the other hand, if the value of C_{B} is positive, the correlation in the direction in which G2 and G3 are located will be higher.

Similarly, to calculate the correlation value C_{R} between the four G-pixels adjacent to an R-pixel, the following equation is used.
C_{R}=|G1−G4|−G2−G3|

The correlation values C_{B} and C_{R} are calculated in a given area centered on an R- or B-pixel location for which G signals are to be calculated, for example, for each R- or B pixel location in an area of 5 rows by 5 columns as shown in FIG. 5. The calculated correlation values C_{B}, C_{R} are sequentially provided to the correlation value filtering unit 302. In FIG. 5, the pixel locations for which neither of the correlation value C_{B} or C_{R} is calculated correspond to G-pixel locations on the solid-state image sensor.

The correlation value filtering unit 302 includes a buffer memory, not shown, and temporarily stores the correlation values C_{B}, C_{R} calculated for each R- or B-pixel location in the 5×5 area in the buffer memory in association with the pixel location and sent from the correlation value calculating unit 300. Then, the correlation value filtering unit 302 applies two-dimensional filtering to the held correlation values to correct them.

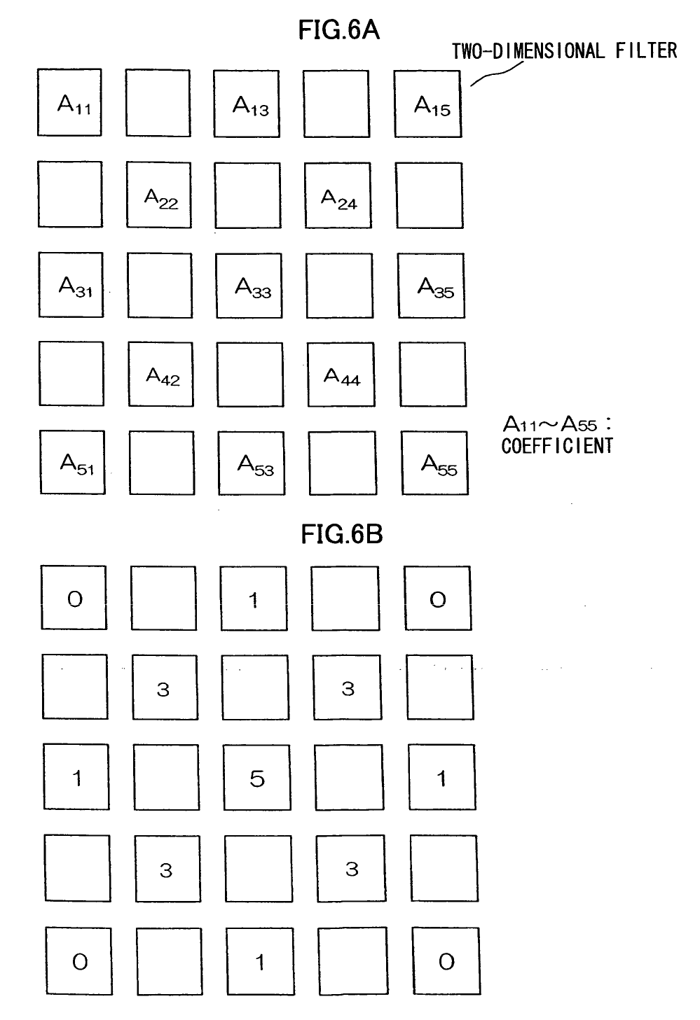

FIG. 6 shows a conceptual diagram of a two-dimensional filter used for the two-dimensional filtering in the present embodiment. In the two-dimensional filter shown in FIG. 6A, coefficients A₁₁-A₅₅ are two-dimensionally provided at the locations for which the correlation values in the 5×5 area shown in FIG. 5 have been calculated. The two-dimensional filter is used to apply two-dimensional filtering to the correlation values arranged in the 5×5 area shown in FIG. 5 for calculating the sum of products of the correlation values and the coefficients at the corresponding locations, as shown in the equation below, thereby obtaining corrected correlation values.
(corrected correlation value)=C_{B11}·A₁₁+C_{B13}·A₁₃+ . . . +C_{B55}·A₅₅

FIG. 6B shows exemplary coefficients used for the two-dimensional filter. The two-dimensional filter shown in FIG. 6B has its largest coefficient at its center. Coefficients nearer the center are greater the coefficients farther from the center. The two-dimensional filter is used for two-dimensional filtering for correcting the correlation value at the center by using correlation values nearby, for example. The two-dimensional filtering is not limited to such calculation. For example, simple averaging in which all coefficients in a two-dimensional space have an equal value or other matrix operations may be used. The correlation values corrected by the correlation value filtering unit 302 are sent to the interpolation direction determining unit 304.

Based on the sign of the correlation values corrected by the correlation value filtering unit 302, the interpolation direction determining unit 304 determines the direction in which the correlation between pixels is strong, that is, the direction (interpolation direction) in which G-pixels that output G signals to be used for calculating the G signal at an R- or B-pixel location are located. The interpolation direction determining unit 304 generates an interpolation direction determining flag for each R- or B-pixel location. The format of the interpolation direction determining flag is not limited to a specific format. For example, the flag may be set to “0” if G signals from G pixels located in the horizontal direction are to be interpolated, and may be set to “1” if G signals from G pixels located in the vertical direction are to be interpolated. The generated interpolation direction determining flag is sent to the interpolation signal generating unit 306.

The interpolation signal generating unit 306 performs interpolation based on the value of the interpolation direction determining flag sent from the interpolation direction determining unit 304. For example, if the flag for the B-pixel location shown in FIG. 4 is set to “0”, G signals from G-pixels in the horizontal direction are to be interpolated. Accordingly, the interpolation signal generating unit 306 generates the G signal GB at the B-pixel location by averaging G signals from the two G pixels (G2 and G3) adjacent to the B pixel in the horizontal direction as follows.
G_{B}=(G2+G3)/2

On the other hand, if the flag for the same location is set to “1”, G signals from G pixels in the vertical direction are to be interpolated. Accordingly, the interpolation signal generating unit 306 generates the G signal G_{B} at the B-pixel location by averaging G signals from the two G pixels (G1 and G4) adjacent to the B pixel in the vertical direction as follows.
G_{B}=(G1+G4)/2

Then, the calculated G signal G_{B} is interpolated in the B-pixel location. While interpolation of the G signal at a B-pixel location has been described above, interpolation of the G signal G_{R} at a R-pixel location can be performed in a similar manner.

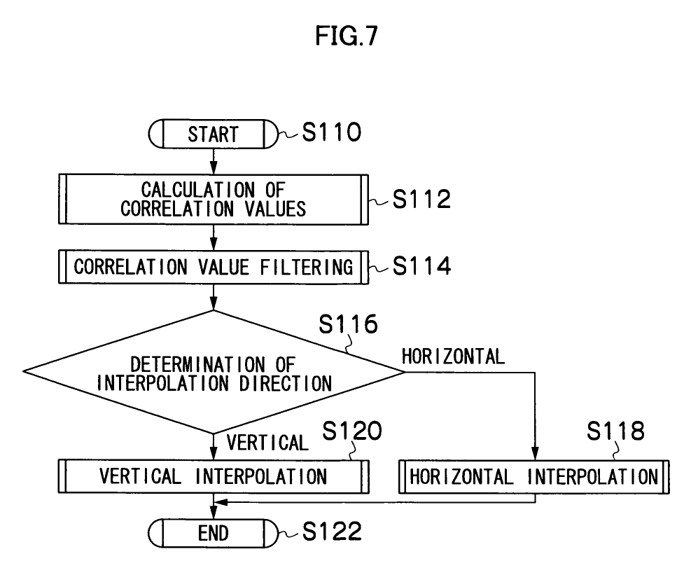

FIG. 7 is a flowchart of signal processing according to the present embodiment. As shown in FIG. 7, data arranged in 3 rows and 3 columns is inputted from the memory 24 into the interpolation unit 30 in the digital signal processing unit 28 under the control of the CPU 26 (step S110). The correlation value calculating unit 300 in the interpolation unit 30 calculates the correlation values between G pixels around an R- or B pixel in the inputted data (step S112). The calculated correlation values are sequentially sent to the correlation value filtering unit 302. On completion of the calculation of the correlation values at the R- and B-pixel locations in a given area, the correlation value filtering unit 302 applies two-dimensional filtering to the correlation values (step S114). The correlation values corrected through the two-dimensional filtering are sent to the interpolation direction determining unit 304. The interpolation direction determining unit 304 determines on the basis of the sign of the corrected correlation values whether the interpolation direction should be horizontal or vertical and generates an interpolation direction determining flag (step S116). The flag is sent to the interpolation signal generating unit 306. The interpolation signal generating unit 306 generates the G signal for the R- or B pixel location according to the flag as described above (steps S118 and S120).

After the calculation of the G signals at the R- or B pixels is completed, R- and B-signal interpolation unit, not shown, calculates the R signals at B- and G-pixel locations and the B signals at R- and G-signal locations. After all of the R, G, and B color signals at all pixel locations in the image data are calculated, the image data is sent to the luminance/chrominance signal generating unit 32, where YC conversion is performed. The YC conversion may be performed on per unit area basis in the image data.

The signal processing method of the present invention can be implemented by a computer program as well. As described earlier, cameras 10 having raw data recording mode are capable of recording CCD-RAW data in a memory card 38. When such CCD-RAW data is to be reproduced and displayed, a memory card 38 in which the CCD-RAW data is recorded is inserted in a computer on which a computer program having the signal processing functions of the present invention is installed, and the CCD-RAW data read from the memory card 38 is reproduced on the monitor of the computer. By using the signal processing apparatus, the signal processing method, and the signal processing program of the present embodiment, the accuracy of the determination of the direction of G signal interpolation can be improved and therefore generation of spurious signals due to interpolation can be suppressed.

### Second Embodiment

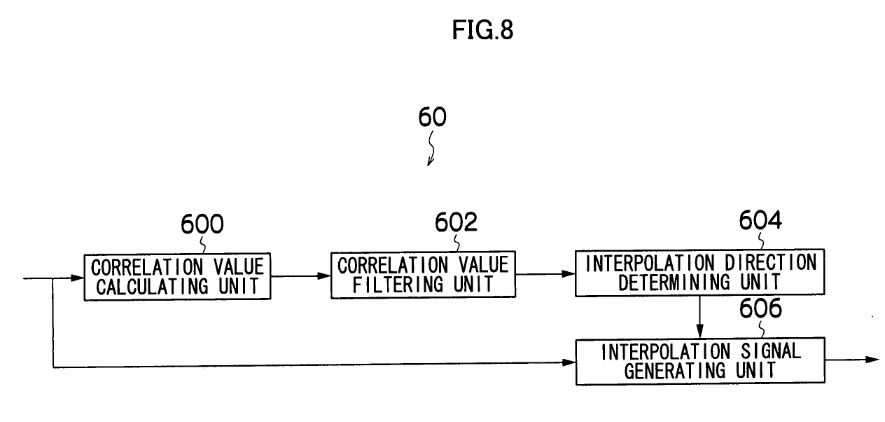

FIG. 8 is a block diagram of an interpolation unit 60 of a signal processing apparatus according to a second embodiment of the present invention. Like the interpolation unit 30 according to the first embodiment, the interpolation unit 60 according to the second embodiment includes a correlation value calculating unit 600, a correlation value filtering unit 602, an interpolation direction determining unit 604, and an interpolation signal generating unit 606. However, the correlation value calculating unit 600 and the correlation value filtering unit 602 performs processes different from the processes performed by those in the first embodiment.

Operation of the interpolation unit 60 configured as described above will be described below. As in the first embodiment, a process for calculating G signals at R- or B-pixel locations will be described.

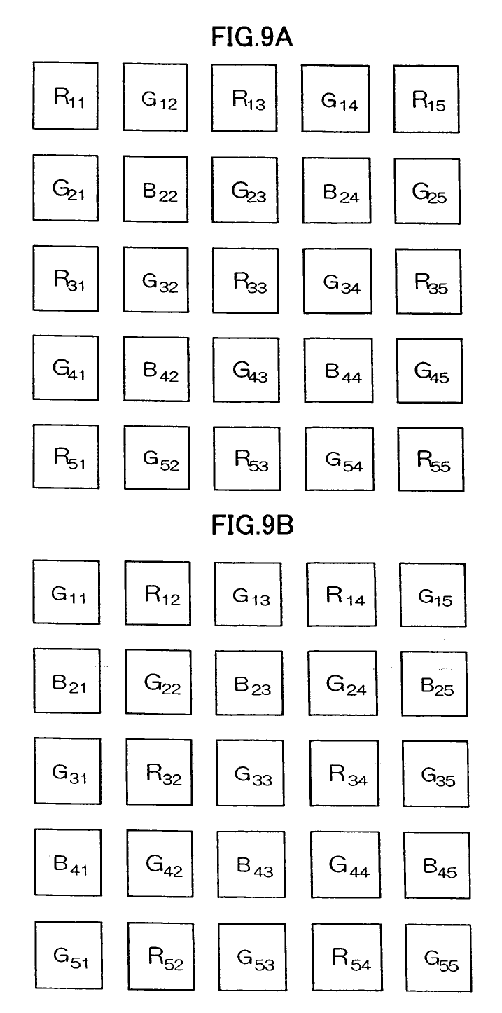

Unlike the correlation value calculating unit 300 of the first embodiment, the correlation value calculating unit 600 calculates the correlation values for all of R, G, and B pixel locations on the image pickup device 16. With reference to FIG. 9A, a process for calculating correlation value between multiple pixels located around an R pixel (R33) in the vertical and horizontal directions will be described. As with the first embodiment, the correlation value calculating unit 600 temporarily stores, in a buffer memory, data arranged in 5 rows and 5 columns, shown in FIG. 9A, inputted from image data stored in a memory 24. The correlation value calculating unit 600 calculates the correlation value C_{R33} between multiple pixels around R33 pixel in the vertical and horizontal directions as follows.
C_{R33}=(|G23−G43|−|G32−G34|)+(|R33−(R13+R53)/2|−|R33−(R31+R35)/2|)

To calculate the correlation value C_{B33} between multiple pixels located around a B pixel in the vertical and horizontal directions, the following equation, which is similar to the equation of C_{R33}, is used.
C_{B33}=(|G23−G43|−|G32−G34|)+(|B33−(B13+B53)/2|−|B33−(B31+B35)/2|)

As mentioned above, the correlation value between multiple pixels located around a G-pixel location in the vertical and horizontal directions is also calculated in the second embodiment. The correlation value C_{G33} between multiple pixels located around a G pixel (G33) in the vertical and horizontal directions as shown in FIG. 9B is calculated according to the following equation.
C_{G33}=(|B23−B43|−|R32−R34|)+(|G33−(G13+G53)/2|−|G33−(G31+G35)/2|)

Correlation values calculated in this way are sequentially sent to the correlation value filtering unit 602.

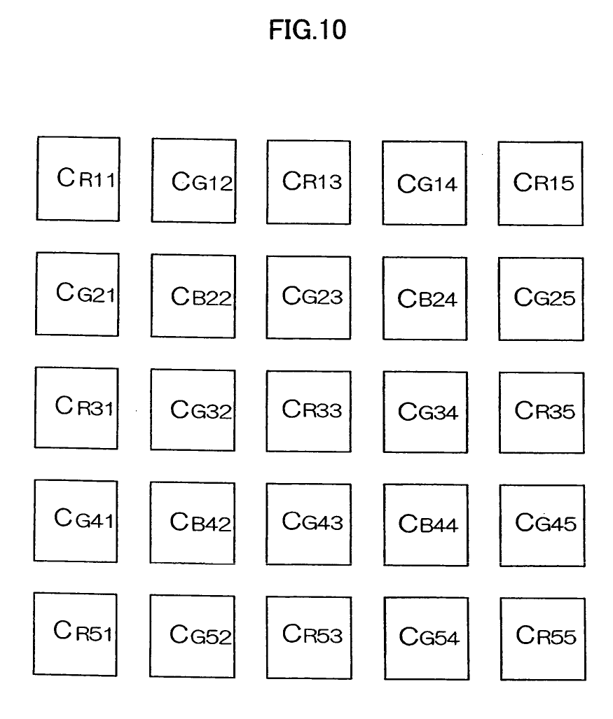

The correlation value filtering unit 602 temporarily holds the correlation values calculated for the R, G, and B pixel locations in the 5×5 area and sent from the correlation value calculation unit 600, in association with the pixel locations as shown in FIG. 10. Then, the correlation value calculating unit 602 applies two-dimensional filtering to the held correlation values to correct them.

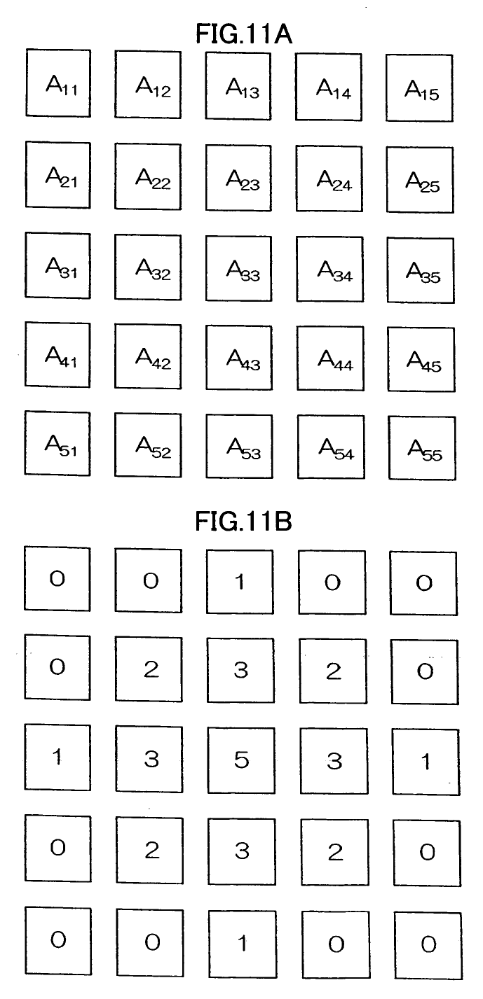

FIG. 11 shows a conceptual diagram of a two-dimensional filter used for the two-dimensional filtering in the second embodiment. As shown in FIG. 11A, coefficients A₁₁-A₅₅ are provided at all of R, G, and B pixel locations in the two-dimensional filter. The sum of products of the correlation values and the coefficients as shown in FIG. 11 B at the corresponding locations is calculated in a manner similar to that in the first embodiment. As the result of the two-dimensional filtering, corrected correlation values are yielded.

The two-dimensional filtering is not limited to such calculation. For example, simple averaging in which all coefficients in a two-dimensional space have an equal value or other matrix operations or the like may be used. The correlation values corrected by the correlation value filtering unit 602 are sent to the interpolation direction determining unit 604.

Operations performed by the interpolation direction determining unit 604 and the interpolation signal generating unit 606 are the same as those in the first embodiment and therefore the description of which will be omitted.

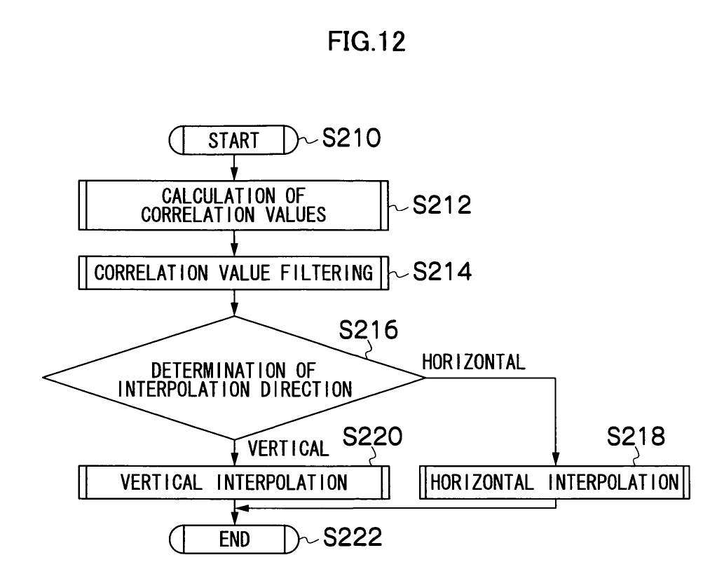

FIG. 12 is a flowchart of signal processing according to the second embodiment. As shown in FIG. 12, data arranged in 5 rows and 5 columns is first inputted from the memory 24 into the interpolation unit 60 in the digital signal processing unit 28 under the control of the CPU 26 (step S210). The correlation value calculating unit 600 in the interpolation unit 60 calculates the correlation values for the R, G, and B pixel locations in the inputted data (step S212). The calculated correlation values are sequentially sent to the correlation value filtering unit 602. After the correlation values in a given area is completed, the correlation value filtering unit 602 applies two-dimensional filtering to the correlation values (step S214). The correlation values corrected through the two-dimensional filtering are sent to the interpolation direction determining unit 604. Operations performed by the interpolation direction determining unit 604 and the interpolation signal generating unit 606 are the same as those in the first embodiment and therefore the description of which will be omitted.

As with the first embodiment, the signal processing method according to the second embodiment can be implemented by a computer program as well. As with the first embodiment, to reproduce and display CCD-RAW data, a memory card 38 in which the CCD-RAW data is recorded is inserted in a computer on which a computer program having the signal processing functions of the present invention is installed, and the CCD-RAW data read from the memory card 38 is reproduced on the monitor of the computer. By using the signal processing apparatus, the signal processing method, and the signal processing program of the second embodiment, the accuracy of the determination of the direction of G signal interpolation can be improved and therefore generation of spurious signals due to interpolation can be suppressed.

### Third Embodiment

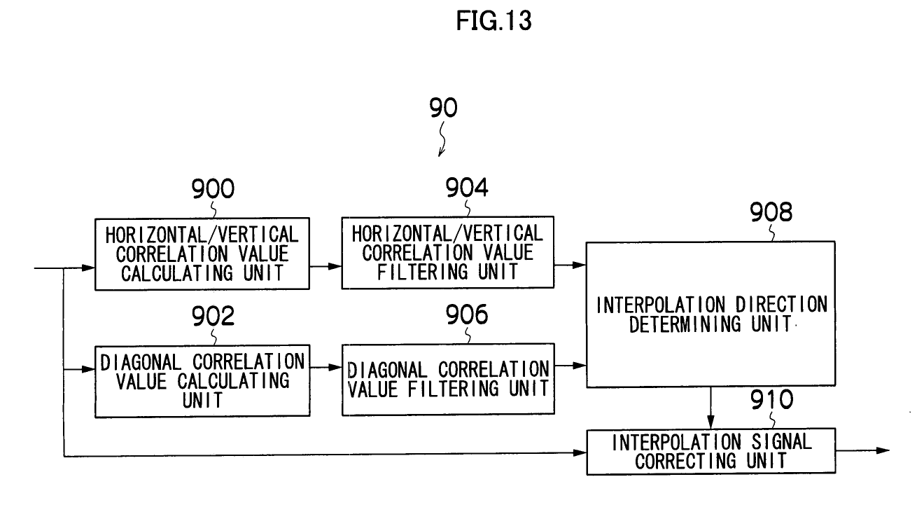

FIG. 13 is a block diagram of an interpolation unit 90 of a signal processing apparatus according to a third embodiment of the present invention. The interpolation unit 90 according to the third embodiment includes a horizontal/vertical correlation value calculating unit 900, a diagonal correlation value calculating unit 902, a horizontal/vertical correlation value filtering unit 904, a diagonal correlation value filtering unit 906, an interpolation direction determining unit 908, and an interpolation signal generating unit 910.

The third embodiment differs from the first and second embodiments in that it includes the diagonal correlation value calculating unit which calculates correlation values in a third and fourth directions and the diagonal correlation value filtering unit.

Operation of the interpolation unit 90 configured as described above will be described below. As in the first and second embodiments, a process for calculating G signals at R or B pixel locations will be described.

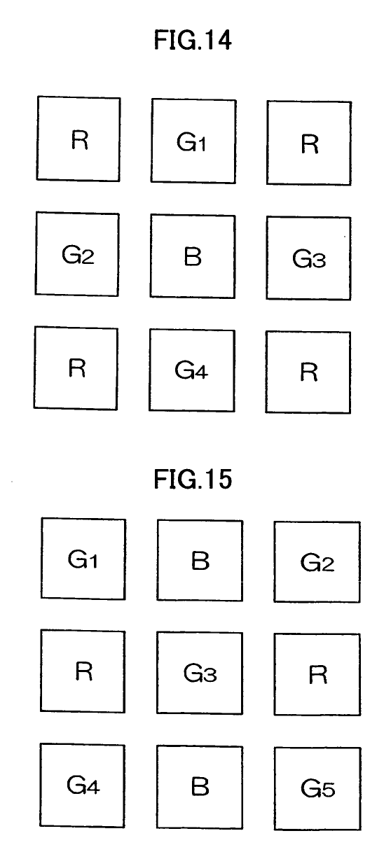

The horizontal/vertical correlation value calculating unit 900, like the correlation value calculating unit 300 in the first embodiment, calculates the correlation value between G pixels adjacent to an R- or B-pixel location in data consisting of 3 rows and 3 columns as shown in FIG. 14. The calculated correlation values are sequentially sent to the horizontal/vertical correlation value filtering unit 904. The method for calculating the correlation values is the same as that of the first embodiment and therefore the description of which will be omitted.

The diagonal correlation value calculating unit 902 calculates correlation values between G pixels diagonally adjacent to a G pixel. Data arranged in 3 rows and 3 columns centered on a G pixel as shown in FIG. 15 is inputted into the diagonal correlation value calculating unit 902. The diagonal correlation value calculating unit 902 temporarily stores the data in a buffer memory, which is not shown. The diagonal correlation value calculating unit 902 calculate the correlation value C_{G3} between four G pixels diagonally adjacent to the G pixel (G3) at the center of the 3×3 data stored in the buffer memory as follows.
C_{G3}=|G1−G5|−|G2−G4|

It can be considered that the smaller the absolute value of the difference between color signals, the higher the correlation between the color signals. Therefore, if the value of C_{G3} is negative, the correlation in the direction in which G1 and G5 are located will be higher. On the other hand, if the value of C_{G3} is positive, the correlation in the direction in which G2 and G4 are located will be higher.

The correlation values thus calculated for the G pixel location are sequentially sent to the diagonal correlation value filtering unit 906.

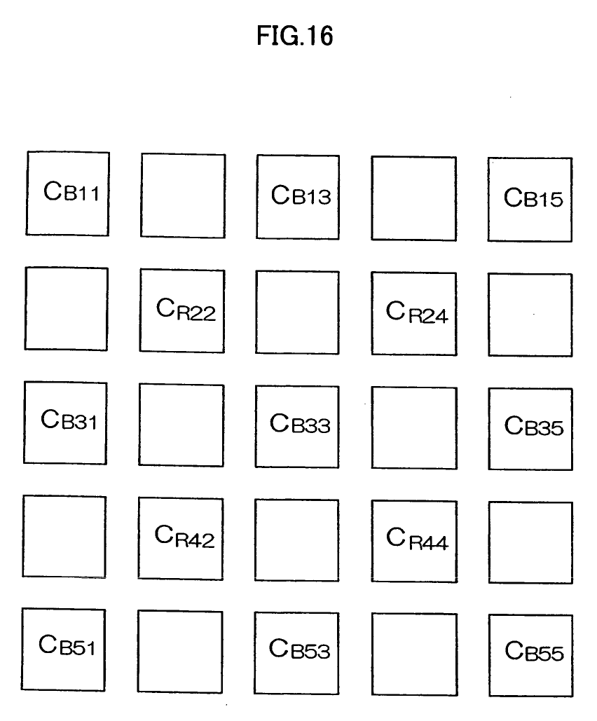

The horizontal/vertical correlation value filtering unit 904 temporarily stores the correlation values calculated for the R- and B-pixel locations in a given area and sent from the correlation value calculating unit 900, as in the first embodiment. FIG. 16 shows the correlation values calculated for the R- and B-pixel locations in an area of 5 rows by 5 columns. Like the correlation value filtering unit 302 in the first embodiment, the horizontal/vertical correlation value filtering unit 904 applies two-dimensional filtering to the correlation values to correct them. The operation performed by the two-dimensional filtering unit is the same as that of the correlation value filtering unit in the first embodiment and therefore detailed description of which will be omitted. The correlation values corrected by the horizontal/vertical correlation value filtering unit 904 are sent to the interpolation direction determining unit 908.

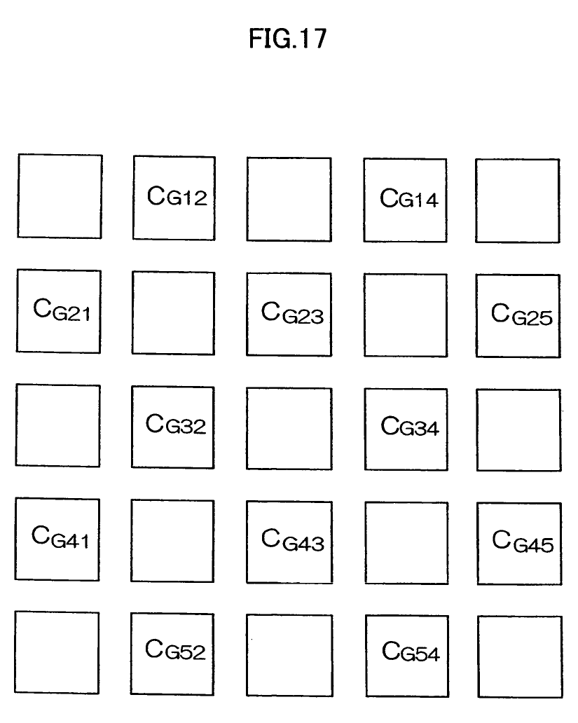

The diagonal correlation value filtering unit 906 temporarily stores the correlation values calculated for the G pixel locations in a given area and sent from the diagonal correlation value calculating unit 902 in a buffer memory. FIG. 17 shows the correlation values calculated for the G-pixel locations in the area of 5 rows by 5 columns. The diagonal correlation value filtering unit 906 then applies two-dimensional filtering to the stored correlation values to correct them.

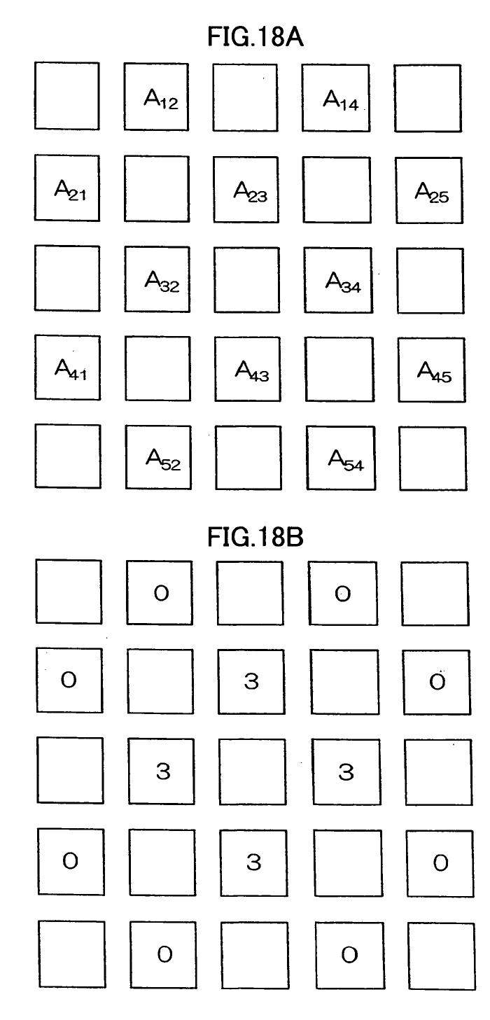

FIG. 18 shows a two-dimensional filter used in the diagonal correlation value filtering unit in the third embodiment. In this embodiment, coefficients A₁₂-A₅₄ are provided at the G-pixel locations as shown in FIG. 18A. For example, the sum of the products of the coefficients, as shown in FIG. 18B and the correlation values at the corresponding locations is calculated, as in the first embodiment. As the result of the two-dimensional filtering, corrected correlation values are yielded.

The two-dimensional filtering is not limited to such calculation. For example, simple averaging in which all coefficients in a two-dimensional space have an equal value or other matrix operations or the like may be used. The correlation values corrected by the diagonal correlation value filtering unit 906 are sent to the interpolation direction determining unit 908.

The interpolation direction determining unit 908 compares the absolute values of the correlation values sent from the horizontal/vertical correlation value filtering unit 904 and the diagonal correlation value filtering unit 906 to determine the interpolation direction. Then the interpolation direction determining unit 908 generates an interpolation direction determining flag based on the determined interpolation direction.

The format of the interpolation direction determining flag is not limited to a specific format. For example, the flag may be set to “0”, “1”, “2”, or “3”, where “0” may indicate horizontal interpolation, “1” may indicate vertical interpolation, “2” may indicate lower-left to upper-right diagonal interpolation, and “3” may indicate upper-left to lower-right diagonal interpolation. The interpolation direction determining flag generated is sent to the interpolation signal generating unit 910.

The interpolation signal generating unit 910 performs interpolation in accordance with the value of the interpolation direction determining flag sent from the interpolation direction determining unit 908. Horizontal interpolation and vertical interpolation are the same as those in the first embodiment and therefore the description of which will be omitted.

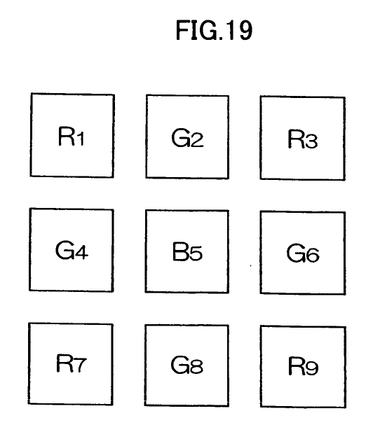

Diagonal interpolation will be described below with respect to an example shown in FIG. 19 in which the G signal (G_{B5}) at the pixel B5 location is calculated through upper-left to lower-right diagonal interpolation. First, the difference between the average of G signals obtained from the four G pixels around pixel B5 and the average of R signals obtained from the four R pixels is calculated. It can be considered that the smaller the difference, the higher the correlation between a G pixel and an R pixel. Therefore, the value of a (where a=a value from 0 to 1) in the following equation is Minimized.
G_{B5}={(R1+R9)/2+(G2+G4+G6+G8)/4−(R1+R3+R7+R9)/4}×(1−a)+{(G2+G4+G6+G8)/4}×a

A smaller value of a decreases the ratio of the average of the G signals obtained from the four G pixels to G_{B5}. The greater the value of a, the greater the ratio of the average of the G signals to G_{B5}. The interpolation signal generating unit 910 interpolates the G signal thus calculated in the pixel B5 location. With this, diagonal resolution can be improved.

Lower-left to upper-right interpolation can also be performed based on the same concept. While G signal interpolation at a B-pixel location has been described, G signal interpolation at an R-pixel location can be accomplished through a similar process.

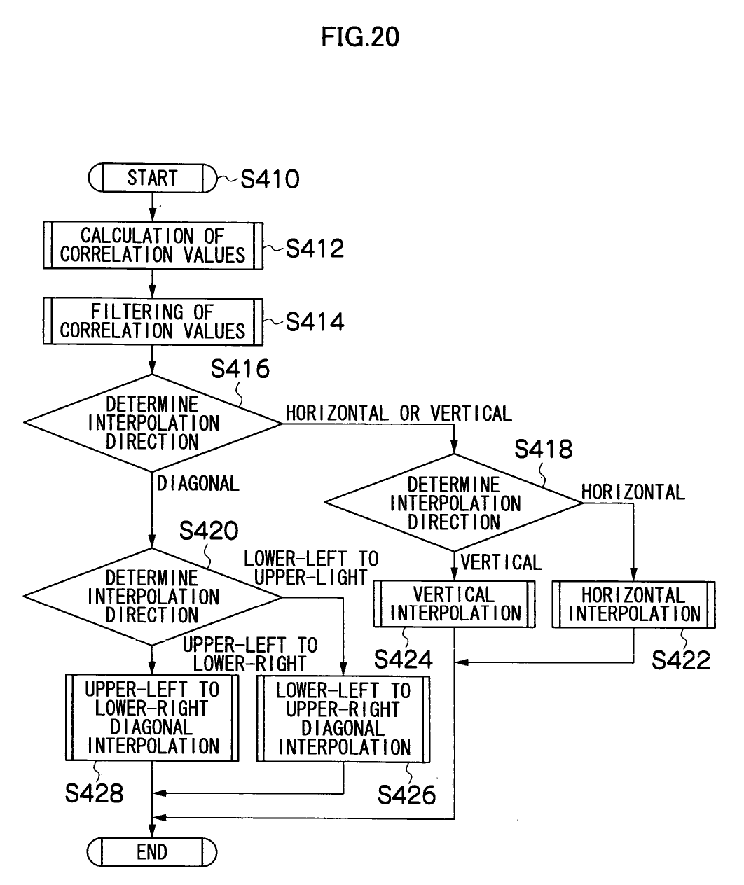

FIG. 20 is a flowchart of signal processing according to the third embodiment. As shown in FIG. 20, first, data consisting of three rows and three columns is inputted from the memory 24 to the interpolation unit 90 in the digital signal processing unit 28 under the control of CPU 26 (step S410). The horizontal/vertical correlation value calculating unit 900 and the diagonal correlation value calculating unit 902 in the interpolation unit 90 calculate correlation values for R-, G-, and B-pixel locations in the inputted data (step S412). The calculated correlation values are sequentially sent to the horizontal/vertical correlation value filtering unit 904 or the diagonal correlation value filtering unit 906. After the calculation of the correlation values in a given area is completed, two-dimensional filtering is performed in the horizontal/vertical correlation value filtering unit 904 and the diagonal correlation value filtering unit 906 (step S414). The correlation values corrected by the two-dimensional filtering are sent to the interpolation direction determining unit 908. The interpolation direction determining unit 908 determines which of horizontal/vertical interpolation and diagonal interpolation should be performed and generates a flag based on the determination (steps S416 to S420). The interpolation signal generating unit 910 performs interpolation according to the flag (steps S422 to S428).

The signal processing method according to the third embodiment, like those in the first and second embodiment, can be implemented by a computer program as well. As in the first and second embodiment, to reproduce and display CCD-RAW data, a memory card 38 in which the CCD-RAW data is recorded is inserted in a computer on which a computer program having the signal processing functions of the present invention is installed, and the CCD-RAW data read from the memory card 38 is reproduced on the monitor of the computer. With the signal processing apparatus, the signal processing method, and the signal processing program of the second embodiment, the accuracy of the determination of the direction of G signal interpolation can be improved and therefore generation of spurious signals due to interpolation can be suppressed. Furthermore, diagonal resolution of an image can be improved as a result of the signal processing.

While the first to third embodiments have been described with respect to interpolation of color signals outputted from an image pickup device including Bayer-pattern color filters, the present invention is not limited to such devices. The present invention can be applied to image pickup devices including color filters with a honeycomb pattern, which is a Bayer pattern rotated to 45 degrees, or color filters with a G-stripe R/B complete checkerboard pattern.

What is claimed is:

1. A signal processing apparatus which obtains a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing apparatus comprising:
a first correlation value calculating unit which calculates, from the values of color signals obtained from a plurality of pixels around the R-pixel location or the B-pixel location in a first direction and a plurality of pixels around the R-pixel location or the B-pixel location along a second direction different from the first direction, a first correlation value representing the degree of correlation along the first direction and along the second direction different from the first direction;
a second correlation value calculating unit which calculates a second correlation value representing the degree of correlation along the first direction and along the second direction by applying two-dimensional filtering to the first correlation value calculated for each R- or B-pixel location in a given two-dimensional range around the R- or B-pixel location;
an interpolation direction determining unit which determines, on the basis of the second correlation value, which of the first and second directions has a higher correlation; and
an interpolation unit which interpolates color signals obtained from the pixels located along the direction determined by the interpolation direction determining unit to calculate a G color signal at the R-pixel location or the B-pixel location.

2. A signal processing apparatus which obtains a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing apparatus comprising:
a first correlation value calculating unit which calculates, from the values of color signals obtained from a plurality of pixels around the R-pixel location, the B-pixel location, and the G-pixel location in a first direction and a plurality of pixels around the R-pixel location or the B-pixel location along a second direction different from the first direction, a first correlation value representing the degree of correlation along the first direction and along the second direction different from the first direction;
a second correlation value calculating unit which calculates a second correlation value representing the degree of correlation along the first direction and along the second direction by applying two-dimensional filtering to the first correlation value calculated for each R-, B-, or G-pixel location in a given two-dimensional range around the R- or B-pixel location;
an interpolation direction determining unit which determines, on the basis of the second correlation value, which of the first and second directions has a higher correlation; and
an interpolation unit which interpolates color signals obtained from the pixels located along the direction determined by the interpolation direction determining unit to calculate a G color signal at the R-pixel location or the B-pixel location.

3. A signal processing apparatus which obtains a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing apparatus comprising:
a first correlation value calculating unit which calculates, from the values of color signals obtained from a plurality of pixels around the R-pixel location or the B-pixel location in a first direction and a plurality of pixels around the R-pixel location or the B-pixel location along a second direction different from the first direction, a first correlation value representing the degree of correlation along the first direction and along the second direction different from the first direction;
a second correlation value calculating unit which calculates, from the values of color signals obtained from a plurality of pixels around the G-pixel location in a third direction different from the first and second directions and a plurality of pixels around the G-pixel location along a fourth direction different from the third direction, a second correlation value representing the degree of correlation along the third direction and along the fourth direction;
a third correlation value calculating unit which calculates a third correlation value representing the degree of correlation along the first direction and along the second direction by applying two-dimensional filtering to the first correlation value calculated for each R- or B-pixel location in a given two-dimensional range around the R- or B-pixel location;
a fourth correlation value calculating unit which calculates a fourth correlation value representing the degree of correlation along the third direction and along the fourth direction by applying two-dimensional filtering to the second correlation value calculated for each G-pixel location in a given two-dimensional range around the R- or B-pixel location;
an interpolation direction determining unit which determines, on the basis of the third and fourth correlation values, which of the first, second, third, and fourth directions has the highest correlation; and
an interpolation unit which calculates a G color signal at the R-pixels location or the B-pixel location by interpolating color signals obtained from the pixels located along the direction that is determined by the interpolation direction determining unit as having the highest correlation, or by performing weighted interpolation of color signals of pixels along the direction that has the highest correlation and color signals of pixels along another direction.

4. A signal processing method for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing method comprising the steps of:
calculating, from the values of color signals obtained from a plurality of pixels around the R-pixel location or the B-pixel location in a first direction and a plurality of pixels around the R-pixel location or the B-pixel location along a second direction different from the first direction, a first correlation value representing the degree of correlation along the first direction and along the second direction different from the first direction;
calculating a second correlation value representing the degree of correlation along the first direction and along the second direction by applying two-dimensional filtering to the first correlation value calculated for each R- or B-pixel location in a given two-dimensional range around the R- or B-pixel location;
determining, on the basis of the second correlation value, which of the first and second directions has a higher correlation; and
interpolating color signals obtained from the pixels located along the direction determined by the interpolation direction determining unit to calculate the G color signal at the R-pixel location or the B-pixel location.

5. A signal processing method for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing method comprising the steps of:
calculating, from the values of color signals obtained from a plurality of pixels around the R-pixel location, the B-pixel location, and the G-pixel location in a first direction and a plurality of pixels around the R-pixel location, the B-pixel location or the G-pixel location along a second direction different from the first direction, a first correlation value representing the degree of correlation along the first direction and along the second direction different from the first direction;
calculating a second correlation value representing the degree of correlation along the first direction and along the second direction by applying two-dimensional filtering to the first correlation value calculated for each R-, B-, or G-pixel location in a given two-dimensional range around the R- or B-pixel location;
determining, on the basis of the second correlation value, which of the first and second directions has a higher correlation; and
interpolating color signals obtained from the pixels located along the direction determined by the interpolation direction determining unit to calculate the G color signal at the R-pixel location or the B-pixel location.

6. A signal processing method for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing method comprising the steps of:
calculating, from the values of color signals obtained from a plurality of pixels around the R-pixel location or the B-pixel location in a first direction and a plurality of pixels around the R-pixel location or the B-pixel location along a second direction different from the first direction, a first correlation value representing the degree of correlation along the first direction and along the second direction different from the first direction;
calculating, from the values of color signals obtained from a plurality of pixels around the G-pixel location in a third direction different from the first and second directions and a plurality of pixels around the G-pixel location along a fourth direction different from the third direction, a second correlation value representing the degree of correlation along the third direction and along the fourth direction;
calculating a third correlation value representing the degree of correlation along the first direction and along the second direction by applying two-dimensional filtering to the first correlation value calculated for each R- or B-pixel location in a given two-dimensional range around the R- or B-pixel location;
calculating a fourth correlation value representing the degree of correlation along the third direction and along the fourth direction by applying two-dimensional filtering to the second correlation value calculated for each G-pixel location in a given two-dimensional range around the R- or B-pixel location;
determining, on the basis of the third and fourth correlation values, which of the first, second, third, and fourth directions has the highest correlation; and
calculating a G color signal at the R-pixels location or the B-pixel location by interpolating color signals obtained from the pixels located along the direction that is determined by the interpolation direction determining unit as having the highest correlation, or by performing weighted interpolation of color signals of pixels along the direction that has the highest correlation and color signals of pixels along another direction.

7. A signal processing program for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing program causing a computer to implement the functions of:
calculating, from the values of color signals obtained from a plurality of pixels around the R-pixel location or the B-pixel location in a first direction and a plurality of pixels around the R-pixel location or the B-pixel location along a second direction different from the first direction, a first correlation value representing the degree of correlation along the first direction and along the second direction different from the first direction;
calculating a second correlation value representing the degree of correlation along the first direction and along the second direction by applying two-dimensional filtering to the first correlation value calculated for each R- or B-pixel location in a given two-dimensional range around the R- or B-pixel location;
determining, on the basis of the second correlation value, which of the first and second directions has a higher correlation; and
interpolating color signals obtained from the pixels located along the direction determined by the interpolation direction determining unit to calculate the G color signal at the R-pixel location or the B-pixel location.

8. A signal processing program for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing program causing a computer to implement the functions of:
calculating, from the values of color signals obtained from a plurality of pixels around the R-pixel location, the B-pixel location, and the G-pixel location in a first direction and a plurality of pixels around the R-pixel location, the B-pixel location or the G-pixel location along a second direction different from the first direction, a first correlation value representing the degree of correlation along the first direction and along the second direction different from the first direction;
calculating a second correlation value representing the degree of correlation along the first direction and along the second direction by applying two-dimensional filtering to the first correlation value calculated for each R-, B-, or G-pixel location in a given two-dimensional range around the R- or B-pixel location;
determining, on the basis of the second correlation value, which of the first and second directions has a higher correlation; and
interpolating color signals obtained from the pixels located along the direction determined by the interpolation direction determining unit to calculate the G color signal at the R-pixel location or the B-pixel location.

9. A signal processing program for obtaining a G color signal at R-pixel location and a B-pixel location on a solid-state image sensor having a color-filter array including at least red, green and blue by interpolating color signals from nearby pixels on the basis of color signals of a plurality of colors outputted from the solid-state image sensor, the signal processing program causing a computer to implement the functions of:
calculating, from the values of color signals obtained from a plurality of pixels around the R-pixel location or the B-pixel location in a first direction and a plurality of pixels around the R-pixel location or the B-pixel location along a second direction different from the first direction, a first correlation value representing the degree of correlation along the first direction and along the second direction different from the first direction;
calculating, from the values of color signals obtained from a plurality of pixels around the G-pixel location in a third direction different from the first and second directions and a plurality of pixels around the G-pixel location along a fourth direction different from the third direction, a second correlation value representing the degree of correlation along the third direction and along the fourth direction;
calculating a third correlation value representing the degree of correlation along the first direction and along the second direction by applying two-dimensional filtering to the first correlation value calculated for each R- or B-pixel location in a given two-dimensional range around the R- or B-pixel location;
calculating a fourth correlation value representing the degree of correlation along the third direction and along the fourth direction by applying two-dimensional filtering to the second correlation value calculated for each G-pixel location in a given two-dimensional range around the R- or B-pixel location;
determining, on the basis of the third and fourth correlation values, which of the first, second, third, and fourth directions has the highest correlation; and
calculating a G color signal at the R-pixels location or the B-pixel location by interpolating color signals obtained from the pixels located along the direction that is determined by the interpolation direction determining unit as having the highest correlation, or by performing weighted interpolation of color signals of pixels along the direction that has the highest correlation and color signals of pixels along another direction.
